(19) United States
(12) Patent Application Publication
(10) Pub. No.: US 2004/0185922 A1
(43) Pub. Date: Sep. 23, 2004

(54) Smartphone with novel opening mechanism

(76) Inventors: Thomas Sutton, Milano (IT); Barbara Tornaghi, Monza (IT)

Correspondence Address: HAVERSTOCK & OWENS LLP, 162 NORTH WOLFE ROAD, SUNNYVALE, CA, 94086, US

(21) Appl. No.: 10/772,905

(22) Filed: Feb. 4, 2004

Related U.S. Application Data
(60) Provisional application No. 60/445,939, filed on Feb. 6, 2003.
(60) Provisional application No. 60/448,982, filed on Feb. 19, 2003.

(51) Int. Cl. H04M 1/00

(52) U.S. Cl. 455/575.1; 455/575.3

(57) ABSTRACT

An electronic device comprises a first substantially planar panel and a second substantially planar panel. The first panel includes a first interface. The second panel includes a second interface and is coupled to the first panel, so that the first panel can rotate relative to the second panel. The device further can be configured in one of two positions. In the first position, the second interface is obscured by the first panel. In the second position, the first panel partitions the second interface into a plurality of exposed sections. The device can be a wireless telecommunications device with a telephone interface as the first interface, a keyboard as the second interface, and a digital camera lens. The device provides simultaneous accessibility of multiple elements based on its configuration.

### RELATED APPLICATIONS

This application claims priority under 35 U.S.C. § 119(e) of the co-pending U.S. provisional application, Serial No. 60/448,982, filed on Feb. 19, 2003 and entitled “SMARTPHONE WITH NOVEL OPENING MECHANISM AND PERSONAL ENTERTAINMENT DEVICE (PDE) WITH DOUBLE-OPENING FLAP” and the co-pending U.S. provisional application, Serial No. 60/445,939, filed on Feb. 6, 2003 and entitled “INTEGRATED CELLULAR PHONE, DIGITAL CAMERA, AND PDA, WITH SWIVEL MECHANISM PROVIDING ACCESS TO THE INTERFACE ELEMENTS OF EACH FUNCTION AND MAIN MENU NAVIGATION PRINCIPLE FOR MOBILE PHONE USER.” The provisional application, Serial No. 60/448,982, filed on Feb. 19, 2003 and entitled “SMARTPHONE WITH NOVEL OPENING MECHANISM AND PERSONAL ENTERTAINMENT DEVICE (PDE) WITH DOUBLE-OPENING FLAP” and the provisional application, Serial No. 60/445,939, filed on Feb. 6, 2003 and entitled “INTEGRATED CELLULAR PHONE, DIGITAL CAMERA, AND PDA, WITH SWIVEL MECHANISM PROVIDING ACCESS TO THE INTERFACE ELEMENTS OF EACH FUNCTION AND MAIN MENU NAVIGATION PRINCIPLE FOR MOBILE PHONE USER,” are also hereby incorporated by reference.

### FIELD OF THE INVENTION

The present invention relates to the field of cellular phones. More particularly, the present invention relates to the field of multifunctional cellular phones.

### BACKGROUND OF THE INVENTION

With fast-paced living of today, consumers are buying more multifunctional cellular phones to keep up with their lifestyle. However, conventional multifunctional phones fail in several respects to serve all the needs of multitasking consumers. First, conventional phones do not allow for simultaneous access to multiple functional elements, such as a digital camera, a telephone interface with a numeric keypad, and a qwerty keyboard. Instead, consumers are forced to choose only one element to be operational in any given moment, thereby prohibiting efficient multitasking. Second, phones with both a numeric keypad and a qwerty keyboard typically require two or more displays, thereby increasing the footprint of the device. Third, conventional phones fail to provide an ergonomic layout of the functional elements. Oftentimes, in an effort to integrate multiple communication interfaces, conventional cellular phones provide qwerty keyboards or numeric keys in unusual, non-standard arrays. Some conventional cellular phones fail altogether to provide a separate numeric keypad.

What is needed is a multifunctional cellular phone that provides an integrated, ergonomic layout. Specifically, to address the problems noted above, what is needed is a multifunctional cellular phone that allows simultaneous access to multiple elements in a portable unit.

### SUMMARY OF THE INVENTION

The present invention is directed to an electronic device that allows consumers to simultaneously access multiple elements in a convenient ergonomic design layout, without sacrificing the portability of the device. The device can be configured in one of two positions, namely, a first position (also known as the closed position) and a second position (also referred to as the open position). In the first position, only one of the multiple elements is accessible. Preferably, in the first position, the telephone interface with a numeric keypad is accessible. Elements not accessible in the first position are protected. In the second position, multiple elements are simultaneously accessible and the device has an ergonomic design layout in the form of a cross. Preferably, in the second position, a first interface, a second interface, and a digital camera lens of a multifunctional electronic device are accessible.

In one embodiment of the present invention, an electronic device comprises a first substantially planar panel and a second substantially planar panel. The first panel includes a first interface. The second panel includes a second interface and is coupled to the first panel, so that the first panel can rotate relative to the second panel. The device further can be configured in one of two positions. In the first position, the second interface is obscured by the first panel. In the second position, the first panel preferably partitions the second interface into a plurality of exposed sections. Preferably, the device includes a telephone interface as the first interface and a keyboard as the second interface.

In another embodiment, the first panel includes the display. When the device is configured in the first position, the first interface controls the display. When the device is configured in the second position, the second interface controls the display. Alternatively, when the device is in the second position, both the first and the second interfaces control the display.

According to another embodiment of the present invention, when the device is configured in the first position, an entry made on the first interface is displayed on the display. When the device is configured in the second position, an entry made on the second interface is displayed on the display. Alternatively, when the device is in the second position, entries made on both the first interface and the second interface are displayed on the display.

Another embodiment of the present invention provides that the device operates in a first mode when configured in the first position and operates in a second mode when configured in the second position. In the preferred embodiment, the device senses when the device is configured in one of the first position and the second position. The first panel is operatively coupled to the second panel to allow an exchange of electronic data. Preferably, the device is a portable handheld device. Preferably, the device is a telephone.

In another embodiment of the present invention, the first panel further comprises a front side and a back side. The front side of the first panel includes the display and the first interface. The back side of the first panel includes an engaging end. The second panel further comprises a receiving end. Alternatively, the front side of the first panel includes the display and the first interface, and the back side of the first panel includes the receiving end. The second panel further comprises the engaging end. In one of the first position and in the second position, the receiving end receives the engaging end.

In yet another embodiment of the present invention, the device further comprises a digital camera lens. Preferably, the back side of the first panel further comprises the digital camera lens, and the second panel includes a keyboard. In the first position, the keyboard is obscured by the first panel and the digital camera lens is obscured by the second panel. In the second position the keyboard and the digital camera lens are exposed, with the keyboard partitioned by the first panel into a plurality of exposed sections. The device operates in a first mode when configured in the first position with the digital camera lens obscured, operates in the second mode when configured in the second position with the digital camera lens obscured, and operates in a third mode when configured in one of the first position and second position with the digital camera lens exposed. The first mode is the telephone mode, the second mode is the keyboard mode, and the third mode is the camera mode.

In an alternative embodiment, the device further comprises a camera door moveably coupled to the back side of the second panel. When the camera door is open the digital camera lens is exposed. When the camera door is closed the digital camera lens is obscured. With the camera door open, the display shows what the digital camera lens sees. Preferably, when the device is in the first position with the camera door open, the display shows what the digital camera lens sees in a first orientation. When the device is in the second position with the camera door open, the display shows what the digital camera lens sees in a second orientation. Preferably, the second orientation is rotated about 90 degrees from the first orientation. When the device is in the second position, the second panel is rotated about 90 degrees from the first panel.

### BRIEF DESCRIPTION OF THE DRAWINGS

FIGS. 1A and 1B are schematic drawings showing an electronic device in a first position, depicting the front side of the first panel and a back side of the second panel, respectively.

FIGS. 2A and 2B are schematic drawings showing the front view and the back view, respectively, of the device in FIG. 1A in a second position. FIGS. 2A and 2B include intermediate views.

FIGS. 3A, 3B, and 3C are schematic drawings showing various alternative embodiments of the device with and without a digital camera lens and a camera door.

### DETAILED DESCRIPTION OF THE PRESENT INVENTION

The present invention provides the convenience of a multifunctional cellular phone comprising multiple elements in a more ergonomic, user-friendly format. This invention further allows one element to be accessible in one position, with the remaining elements protected. In a second position, multiple elements are simultaneously accessible. Finally, the invention permits multiple elements to control the display in the second position.

Specifically, to address the problems of accessing multiple elements in a multifunctional device, an electronic device in accordance with the present invention comprises a first substantially planar panel and a second substantially planar panel. The first panel includes a display and includes a first interface. The second panel includes a second interface and is coupled to the first panel. The first and second panels rotate about an asymmetric axis.

The electronic device is configured in one of two positions. In a first position (the closed position), the second panel is obscured by the first panel, reducing the footprint of the device. When in the first position, the device is more portable and compact. In the first position, the second interface is obscured and is protected from the potential risks of dust, dirt, external damage, and the like. Preferably, the first interface is included on the front side of the first panel and the second interface is included on the front side of the second panel. Because the second interface is obscured in the first position, the second interface is not accessible. In contrast, when the device is configured in a second position (the open position), the first panel partitions the second interface into a plurality of exposed sections. In the second position, both the first interface and the second interface are exposed. In the preferred embodiment, when the device is in the second position, the first interface and the second interface are simultaneously accessible and they both control the display.

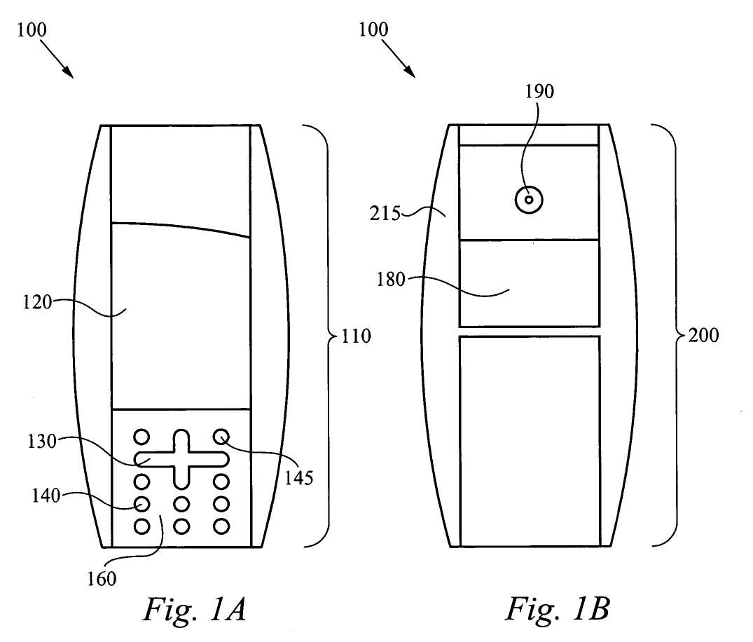

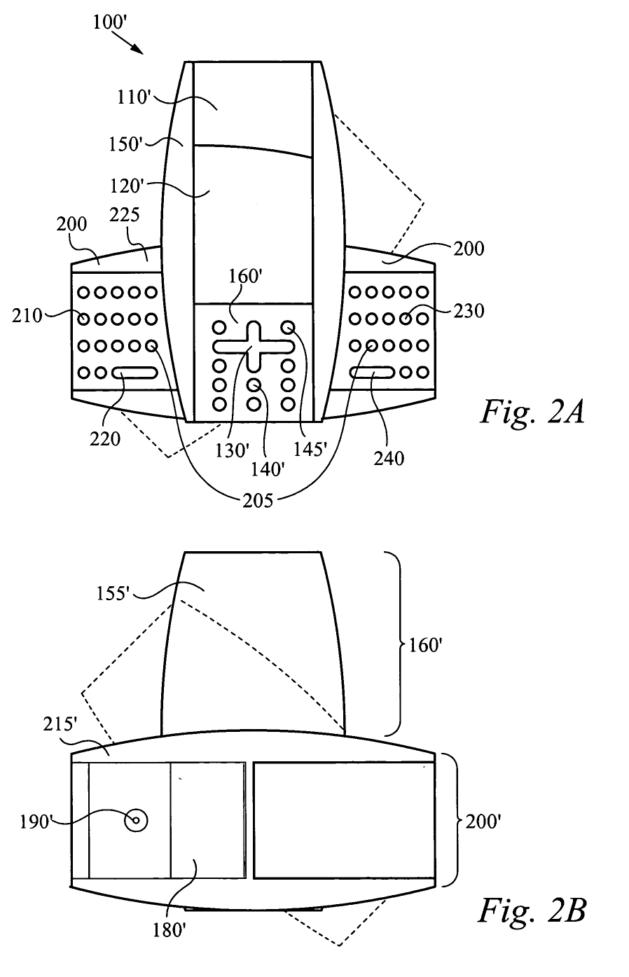

According to the preferred embodiment, in the first position, the electronic device operates as a wireless telecommunications device. FIGS. 1A and 1B show a front view of a first panel 110 and a back view of a second panel 200, respectively, when the electronic device 100 is in a first position. The positions of the device 100 further coincide with the modes of the device 100. In the first position, a first interface 160 controls a display 120, 120′ (FIG. 1A), and in the second position, a second interface 205 controls the display 120, 120′ (FIG. 2A). Alternatively, in the first position, the first interface 160 controls the display 120 and in the second position, both the first interface 160 and the second interface 205 control the display 120 (FIG. 2A). When the device 100, 100′ is configured in the first position, the device 100, 100′ is in the first mode. When the device 100, 100′ is configured in the second position, the device 100, 100′ is in the second mode (FIG. 2A).

The device 100, 100′ further senses when it is configured in one of the first position and the second position. Thus, when the device 100, 100′ is in the first position as shown in FIGS. 1A and 1B, the device 100, 100′ senses the device configuration and the first mode is selected. As described below, when the device 100, 100′ is configured in the second position as shown in FIGS. 2A and 2B, the device 100, 100′ senses the configuration and the second mode is selected. Preferably, the device 100, 100′ further includes a digital camera lens 190 (FIG. 1B). When the digital camera lens 190 is exposed in one of the first position and the second position, a third mode is selected. Preferably, the third mode is the camera mode. Alternatively, the device 100, 100′ with the digital camera lens 190 may further include a camera door 180. When the device 100, 100′ includes a camera door 180, the digital camera lens 190 is exposed and obscured, respectively, upon the opening and closing of the camera door 180. Preferably, the camera door 180 is a sliding door. The device senses when it is configured in one of the first position and the second position with the camera door 180 open and closed, respectively. Preferably, when the device 100, 100′ is configured in one of the first position and the second position with the camera door 180 open, the device 100, 100′ is in both the first mode (phone mode) and the third mode (camera mode). Conversely, when the device 100, 100′ is configured in one of the first position and the second position with the camera door 180 closed, the device 100, 100′ will only be in the first mode (phone mode). The third mode is not available when the camera door 180 is closed and the digital camera lens 190 is obscured.

Still referring to FIGS. 1A and 1B, when the device 100 is in the first position, the first interface 160 is accessible, while the second interface 205 (FIG. 2A) on the second panel 200 is obscured by the first panel 110. In the preferred embodiment, as shown in FIG. 1A, the first interface 160 is a telephone interface, which includes a display 120, a numeric keypad 140, control buttons 145, and function keys 130 on the front side 150 of the first panel 110. Preferably, the first mode is referred to as the phone mode.

Further, in the first position, an entry made on the first interface 160 is displayed on the display 120 (FIG. 1A). In the second position, an entry made on the second interface 205 is displayed on the display 120′ (FIG. 2A). An entry can include keystrokes on a numeric keypad, control buttons, function keys, alphabetic keyboard or a qwerty keyboard, a movement on a touch key pad, a movement on a scroll bar or a navigation key, and the like. In the preferred embodiment, turning to FIG. 1A, when the device 100 is configured in the first position, an entry made on the numeric keypad 140, controls buttons 145, or function keys 130 on the front side 150 of the first panel 110 are displayed on the display 120. Preferably, the device 100 is a portable handheld device. Preferably, the device 100 is a telephone.

Turning to FIG. 1B, according to the preferred embodiment of the present invention, when the device 100, 100′ is in the first position, the back side 215 of the second panel 200 further comprises a digital camera lens 190 and a camera door 180. When the device 100, 100′ is configured in the first position with the digital camera lens 190 obscured, the device 100, 100′ operates only in a first mode. Preferably, the first mode is a telephone mode. The device 100, 100′ operates in a second mode when configured in the second position with the digital camera lens 190 obscured. Preferably, the second mode is keyboard mode. The device 100, 100′ operates in a third mode when configured in one of the first position and the second position with the digital camera lens 190 exposed. Preferably, the third mode is camera mode. Preferably, the digital camera lens 190 is exposed and obscured by the opening and closing, respectively, of the camera door 180.

FIGS. 2A and 2B show a front view and a back view, respectively, of the electronic device 100, 100′ of FIGS. 1A and 1B configured in the second position. FIG. 2A shows the device 100, 100′ from a front view. Preferably, in the second position, the second panel 200 is rotated about 90 degrees from the first panel 110′. The first panel 110′ of the device 100, 100′ is operatively coupled to the second panel 200 to allow an exchange of electronic data signals. Also, the device 100, 100′ is configured in the second position when the first panel 110′ partitions the second interface 205 into a plurality of exposed sections 210 and 230. Preferably, the second interface 205 is included on the front side 225 of the second panel 200. Preferably, the second interface 205 is a keyboard which is partitioned into two exposed keyboard sections 210 and 230 by the first panel 110′. Preferably, the keyboard is a qwerty keyboard. The exposed keyboard sections 210 and 230 can further include control buttons 220 and 240 respectively, which may act as space bars or keyboard function keys.

When the device 100, 100′ is configured in the second position, the device 100, 100′ is in the second mode (FIGS. 2A and 2B). The device 100, 100′ senses when the device 100 switches from the first position (FIGS. 1A and 1B) to the second position (FIGS. 2A and 2B). Accordingly, the modes of the device 100, 100′ also switch from the first mode (FIGS. 1A and 1B) to the second mode (FIGS. 2A and 2B).

Referring to FIG. 2A, when the device 100, 100′ is configured in the second position, the second interface 205 controls the display 120′. An intermediate position is shown in ghost lines. Preferably, when the device 100, 100′ is configured in the second position, both the first interface 160 and the second interface 205 control the display 120′. The ability of the display to be controlled by both the first interface 160′ (preferably, the telephone interface, including the numeric keypad 140′) and the second interface 205 (preferably, the keyboard) eliminates the conventional need of two displays. Also, when the device 100, 100′ is in the second position, an entry made on the second interface 205 is displayed on the display 120′. Preferably, when the device 100, 100′ is configured in the second position, entries made on the first interface 160′ and the second interface 205 are displayed on the display 120′. Thus, simultaneous access to both the first interface 160′ and the second interface 205 is allowed in this preferred embodiment of the present invention. Preferably, entries can be made simultaneously on the first interface 160′ (telephone interface) and the exposed sections 210 and 230 of the second interface 205 (keyboard).

FIG. 2A further shows the advantages of the ergonomic, user-friendly layout of the device 100′, while providing access to multiple standard elements. The intermediate position is shown in ghost lines. Conventional cellular phones typically include non-standard numeric keypads and non-standard qwerty keyboards. Sometimes, conventional cellular phones fail to provide a separate numeric keypad apart from a qwerty keyboard. In the preferred embodiment of the present invention, the device 100, 100′ in the second position includes both the numeric keypad 140′ of the telephone interface 160′ and the qwerty keyboard interface 205 in standard arrays, without sacrificing the portability and compactness of the device 100, 100′. Further, since multiple elements are simultaneously accessible in the second position, entries made on both the first interface 160′ and the second interface 205 can be displayed on the display 120′, thereby enhancing the multitasking ability of the device 100, 100′.

FIG. 2B shows the back view of the preferred embodiment in FIGS. 1A and 1B in the second position. The intermediate position is shown in ghost lines. In FIG. 1B, in the first position, when the device 100, 100′ includes the camera door 180 and the digital camera lens 190, the digital camera lens 190 is exposed when the camera door 180 is open. When the camera door 180 is closed with the device 100, 100′ in the first position, the digital camera lens 190 is obscured. Likewise, when the device 100, 100′ is in the second position, as shown in FIG. 2B, the digital camera lens 190′ can be exposed and obscured with the opening and closing, respectively, of the camera door 180′. When the device 100, 100′ is one of the first position (FIGS. 1A and 1B) and the second position (FIGS. 2A and 2B), with the camera door 180, 180′ open, a button in the telephone interface 160 (FIG. 1A) is configured to operate a digital camera operatively coupled to the digital camera lens 190′ (FIGS 1B, 2A, and 2B). Furthermore, in one of the first position (FIGS. 1A and 1B) and the second position (FIGS. 2A and 2B), with the camera door 180, 180′ open, the display 120, 120′ shows what the digital camera lens 190, 190′ sees. Preferably, in the first position with the camera door 180, 180′ open, the display 120, 120′ shows what the digital camera lens 190, 190′ sees in a first orientation and in the second position with the camera door 180, 180′ open, the display 120, 120′ shows what the digital camera lens 190′ sees in a second orientation. Thus, preferably, an image of what the digital camera lens 190, 190′ sees can be taken or transmitted by a pressing of a designated button on the telephone interface 160, 160′ in the first position, and then the digital image can be rotated by switching the device 100, 100′ from the first position to the second position. Alternatively, an image of what the digital camera lens 190′ 190′ sees can be taken or transmitted by a pressing of a designated button on the telephone interface 160, 160′ in the second position, and then the digital image can be rotated by switching the device 100, 100′ from the second position to the first position. Preferably, the second orientation is rotated about 90 degrees from the first orientation.

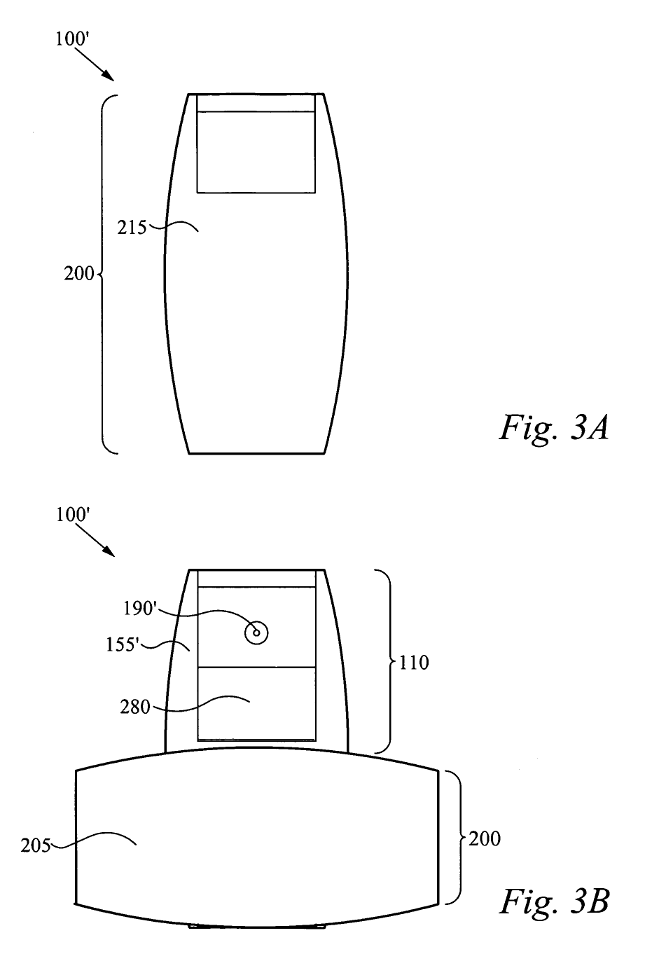

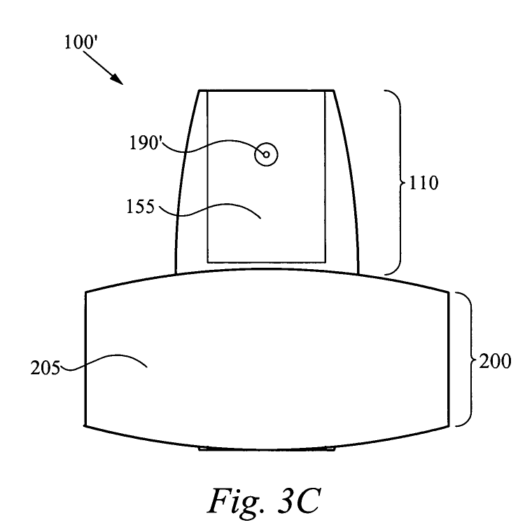

An alternative embodiment of the present invention provides a wireless telecommunications device with a first panel with a front side and a back side and a second panel side including a keyboard. In this alternative embodiment, FIG. 1A shows the front side 150 of the first panel 110, which further includes a display 120 and a telephone interface 160, including a numeric keypad 140, function keys 145, and a navigation key 130. However, as shown in FIG. 3A, in this alternative embodiment, the second panel 200 lacks a digital camera lens or a camera door. Instead, as shown in FIG. 3B, the back side 155 of the first panel 160 can include both the digital camera lens 190′ and an optional camera door 280. In this case, the digital camera lens 190 can only be exposed if the camera door 280 is open and the device 100, 100′ is in the second position (FIG. 3B). Preferably, the device 100, 100′ operates in a first mode when configured in the first position with the optional camera door 280 closed. The device 100 operates in the second mode when configured in the second position with the optional camera door 280 closed. Preferably, the device 100, 100′ operates in a third mode when configured in one of the first position and the second position with the optional camera door 280 open. Preferably, the first mode is the telephone mode, the second mode is the keyboard mode, and the third mode is the camera mode. Thus, the device 100, 100′ is in the third mode (camera mode) when the digital camera lens 190 is exposed with the optional camera door 280 open in the second position. The device 100, 100′ senses when it is configured in one of the first position and the second position with the optional camera door 280 open and closed, respectively.

In yet another alternative embodiment, the device 100, 100′ can have the digital camera lens 190′ without a camera door on the back side 155 of the first panel 160′. In the first position, the second panel 200 obscures the digital camera lens 190′ located on the back side 155 of the first panel 160. Preferably, as shown in FIGS. 1A and 3A, the device 100, 100′ operates in a first mode (telephone mode) when configured in the first position with the keyboard and the digital camera lens obscured. Preferably, the device 100, 100′ operates in the second mode (keyboard mode) when the device 100, 100′ is in the second position with the keyboard 205 exposed (FIGS. 2A and 3C). Preferably, the device 100, 100′ operates in a third mode (camera mode) when configured in the second position with the digital camera lens 190′ exposed. Thus, it is only when the device 100, 100′ is in the second position, with the digital camera lens 190 exposed, that the device 100, 100′ can be simultaneously in the second mode (keyboard mode) and the third mode (camera mode).

Furthermore, the present invention allows for the first panel and the second panel to positively orient itself into one of the first position and the second position, through the use of engaging ends and receiving ends on different panels. In the preferred embodiment, the engaging ends are bumps and the receiving ends are dimples which are sized to receive the bumps of the engaging ends. In one embodiment of the invention, the first panel further comprises a front side and a back side. The front side of the first panel includes a display and the first interface, and the back side of the first panel includes an engaging end. The second panel further comprises a receiving end. When the device is in one of the first position and in the second position, the receiving end of the second panel receives the engaging end of the first panel. Alternatively, the first panel further comprises a front side and a back side, with the front side of the first panel including a display and the first interface, and the back side of the first panel including a receiving end. The second panel then further comprises an engaging end. In this alternative embodiment, when the device is in one of the first position and the second position, the receiving end of the first panel receives the engaging end of the second panel.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. An electronic device comprising:
a. a first substantially planar panel including a first interface; and
b. a second substantially planar panel including a second interface, coupled to the first substantially planar panel such that the first substantially planar panel rotates relative to the second substantially planar panel,
wherein in a first position the second interface is obscured by the first panel and in a second position the first panel partitions the second interface into a plurality of exposed sections.

2. The device according to claim 1, wherein the first panel includes a display, such that when the device is configured in the first position, the first interface controls the display and when the device is configured in the second position, the second interface controls the display.

3. The device according to claim 1, wherein the first panel includes a display, such that when the device is configured in the first position, the first interface controls the display and when the device is configured in the second position, both the first interface and the second interface control the display.

4. The device according to claim 1, wherein the first panel includes a display, such that when the device is configured in the first position, an entry made on the first interface is displayed on the display, and when the device is configured in the second position, an entry made on the second interface is displayed on the display.

5. The device according to claim 1, wherein the first panel includes a display, such that when the device is configured in the first position, an entry made on the first interface is displayed on the display, and when the device is configured in the second position, entries made on the first interface and the second interface are displayed on the display.

6. The device according to claim 1, wherein the device operates in a first mode when configured in the first position and operates in a second mode when configured in the second position.

7. The device according to claim 1, wherein the device senses when the device is configured in one of the first position and the second position.

8. The device according to claim 1, wherein the first panel is operatively coupled to the second panel to allow an exchange of electronic data.

9. The device according to claim 1, wherein the device is a portable handheld device.

10. The device according to claim 1, wherein the device is a telephone.

11. The device according to claim 1, wherein the first panel further comprises a front side and a back side, wherein the front side of the first panel includes a display and the first interface, and the back side of the first panel includes an engaging end.

12. The device according to claim 11, wherein the second panel further comprises a receiving end.

13. The device according to claim 12, wherein in one of the first position and in the second position, the receiving end receives the engaging end.

14. The device according to claim 1, wherein the first panel further comprises a front side and a back side, wherein the front side of the first panel includes a display and the first interface, and the back side of the first panel includes a receiving end.

15. The device according to claim 14, wherein the second panel further comprises an engaging end.

16. The device according to claim 15, wherein in one of the first position and in the second position, the receiving end receives the engaging end.

17. The device according to claim 1, wherein the device further comprises a digital camera lens.

18. The device according to claim 17, wherein the device operates in a first mode when configured in the first position with the digital camera lens obscured, operates in the second mode when configured in the second position with the digital camera lens obscured, and operates in a third mode when configured in one of the first position and second position with the digital camera lens exposed.

19. The device according to claim 18, wherein the first mode is a telephone mode, the second mode is a keyboard mode, and the third mode is a camera mode.

20. A wireless telecommunications device comprising:
a. a first substantially planar panel including a display and a telephone interface; and
b. a second substantially planar panel having a front side and a back side, the front side including a keyboard, the back side including a digital camera lens and a camera door, the camera door moveably coupled to the back side, such that when the camera door is open the digital camera lens is exposed, and when the camera door is closed the digital camera lens is obscured, the second panel coupled to the first panel such that the first panel rotates relative to the second panel, such that in a first position the keyboard is obscured by the first panel and in a second position the keyboard is partitioned by the first panel into a plurality of exposed sections.

21. The wireless telecommunications device according to claim 20, wherein in the first position an entry made on the telephone interface is displayed on the display and in the second position an entry made on the keyboard is displayed on the display.

22. The wireless telecommunications device according to claim 20, wherein in the first position an entry made on the telephone interface is displayed on the display and in the second position, entries made on both the keyboard and the telephone interface are displayed on the display.

23. The wireless telecommunications device according to claim 20, wherein in one of the first position and the second position, with the camera door open, a button in the telephone interface is configured to operate a digital camera operatively coupled to the digital camera lens.

24. The wireless telecommunications device according to claim 20, wherein in one of the first position and the second position, with the camera door open, the display shows what the digital camera lens sees.

25. The wireless telecommunications device according to claim 20, wherein in the first position with the camera door open, the display shows what the digital camera lens sees in a first orientation and in the second position with the camera door open, the display shows what the digital camera lens sees in a second orientation.

26. The wireless telecommunications device according to claim 25, wherein the second orientation is rotated about 90 degrees from the first orientation.

27. The wireless telecommunications device according to claim 20, wherein in the second position, the second panel is rotated about 90 degrees from the first panel.

28. The wireless telecommunications device according to claim 20, wherein the device operates in a first mode when configured in the first position with the camera door closed, operates in the second mode when configured in the second position with the camera door closed, and operates in a third mode when configured in one of the first position and second position with the camera door open.

29. The wireless telecommunications device according to claim 28, wherein the first mode is a telephone mode, the second mode is a keyboard mode, and the third mode is a camera mode.

30. The wireless telecommunications device according to claim 20, wherein the device senses when configured in one of the first position and the second position with the camera door closed.

31. The wireless telecommunications device according to claim 20, wherein the device senses when configured in one of the first position and the second position with the camera door open.

32. The wireless telecommunications device according to claim 20, wherein the first panel further comprises a front side and a back side, the front side of the first panel includes the display and the telephone interface, and the back side of the first panel includes an engaging end.

33. The wireless telecommunications device according to claim 32, wherein the second panel further comprises a receiving end.

34. The wireless telecommunications device according to claim 33, wherein in one of the first position and the second position, the receiving end receives the engaging end.

35. The wireless telecommunications device according to claim 20, wherein the first panel further comprises a front side and a back side, the front side of the first panel includes the display and the telephone interface, and the back side of the first panel includes a receiving end.

36. The wireless telecommunications device according to claim 35, wherein the second panel further comprises an engaging end.

37. The wireless telecommunications device according to claim 36, wherein in one of the first position and the second position, the receiving end receives the engaging end.

38. The wireless telecommunications device according to claim 20, wherein the keyboard is a qwerty keyboard.

39. A wireless telecommunications device comprising:
a. a first substantially planar panel having a front side and a back side, the front side including a display and a telephone interface, the back side including a digital camera lens; and
b. a second substantially planar panel including a keyboard, the second panel coupled to the first panel such that the first panel rotates relative to the second panel, such that in a first position the keyboard and the digital camera lens are obscured by the first panel, and in a second position the keyboard and the digital camera lens are exposed, with the keyboard partitioned by the first panel into a plurality of exposed sections.

40. The wireless telecommunications device according to claim 39, wherein the device further comprises a camera door moveably coupled to the back side of the first panel, such that when the camera door is open the digital camera lens is exposed, and when the camera door is closed the digital camera lens is obscured.

41. The wireless telecommunications device according to claim 39, wherein in the first position an entry made on the telephone interface is displayed on the display and in the second position an entry made on the keyboard is displayed on the display.

42. The wireless telecommunications device according to claim 39, wherein in the first position an entry made on the telephone interface is displayed on the display and in the second position, entries made on both the keyboard and the telephone interface are displayed on the display.

43. The wireless telecommunications device according to claim 39, wherein in one of the first position and the second position, with the digital camera lens exposed, a button in the telephone interface is configured to operate a digital camera operatively coupled to the digital camera lens.

44. The wireless telecommunications device according to claim 39, wherein in one of the first position and the second position, with the digital camera lens exposed, the display shows what the digital camera lens sees.

45. The wireless telecommunications device according to claim 39, wherein in the first position with the digital camera lens exposed, the display shows what the digital camera lens sees in a first orientation and in the second position with the digital camera lens exposed, the display shows what the digital camera lens sees in a second orientation.

46. The wireless telecommunications device according to claim 45, wherein the second orientation is 90 degrees rotated from the first orientation.

47. The wireless telecommunications device according to claim 39, wherein in the second position, the second panel is rotated about 90 degrees from the first panel.

48. The wireless telecommunications device according to claim 39, wherein the device operates in a first mode when configured in the first position with the keyboard and the digital camera lens obscured, operates in the second mode when configured in the second position with the keyboard exposed, and operates in a third mode when configured in the second position with the digital camera lens exposed.

49. The wireless telecommunications device according to claim 48, wherein the first mode is a telephone mode, the second mode is a keyboard mode, and the third mode is camera mode.

50. The wireless telecommunications device according to claim 39, wherein the device senses when configured in the first position with the digital camera lens exposed.

51. The wireless telecommunications device according to claim 39, wherein the device senses when the second position with the keyboard exposed.

52. The wireless telecommunications device according to claim 39, wherein the device senses when the digital camera lens is exposed.

53. The wireless telecommunications device according to claim 39, wherein the front side of the first panel includes the display and the telephone interface, and the back side of the first panel includes an engaging end.

54. The wireless telecommunications device according to claim 53, wherein the second panel further comprises a receiving end.

55. The wireless telecommunications device according to claim 54, wherein in one of the first position and the second position, the receiving end receives the engaging end.

56. The wireless telecommunications device according to claim 39, wherein the front side of the first panel includes the display and the telephone interface, and the back side of the first panel includes a receiving end.

57. The wireless telecommunications device according to claim 56, wherein the second panel further comprises an engaging end.

58. The wireless telecommunications device according to claim 57, wherein in one of the first position and the second position, the receiving end receives the engaging end.

59. The wireless telecommunications device according to claim 39, wherein the keyboard is a qwerty keyboard.
